(19) United States
(12) Patent Application Publication
(10) Pub. No.: US 2026/0298179 A1
(43) Pub. Date: Oct. 1, 2026

(54) INTERNAL COMBUSTION ENGINE

(71) Applicant: TOYOTA JIDOSHA KABUSHIKI KAISHA, Toyota-shi (JP)

(72) Inventors: Tomoya OSHIMA, Shizuoka-ken (JP); Koji KUMAGAE, Susono-shi (JP)

(21) Appl. No.: 19/401,412

(22) Filed: Nov. 26, 2025

(30) Foreign Application Priority Data
Mar. 31, 2025 (JP) 2025-059074

(51) Int. Cl. F02M 21/02

(52) U.S. Cl. CPC F02M 21/0245; F02M 21/0275

(57) ABSTRACT

An internal combustion engine using gaseous fuel includes a delivery pipe configured to store the gaseous fuel, a cylinder head including an insertion hole opened to a combustion chamber of the internal combustion engine, an injector, and an elastic member. The injector includes a main body connected to the delivery pipe and a nozzle extending from the main body and inserted into the insertion hole. The injector is configured to inject the gaseous fuel in the delivery pipe from the nozzle into the combustion chamber. The elastic member is disposed in a compressed state between the main body and the cylinder head. The elastic member is configured to apply, to the main body, a force that pushes the main body toward the delivery pipe.

### CROSS-REFERENCE TO RELATED APPLICATIONS

This application is based upon and claims the benefit of priority from Japanese Patent Application No. 2025-059074, filed on Mar. 31, 2025, the entire contents of which are incorporated herein by reference.

### BACKGROUND

### 1. Field

The present disclosure relates to an internal combustion engine.

### 2. Description of Related Art

An internal combustion engine disclosed in JP2005-307775A includes a clamp member that includes two arm portions for supporting an injector, and a bolt hole to which a fixing bolt is attached. The clamp member supports the injector with the two arm portions, and fixes the injector to a cylinder head by fixing the fixing bolt to the cylinder head.

In order to position the injector, the injector may be pressed against the cylinder head by an elastic member such as a spring. When the injector is pressed against the cylinder head by the elastic member, the force pressing the injector against the cylinder head needs to be greater than the combustion pressure of the internal combustion engine.

In particular, when a fuel that tends to produce high combustion pressure in the internal combustion engine, such as a gaseous fuel, is used, the force pressing the injector against the cylinder head needs to be increased accordingly.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an internal combustion engine using a gaseous fuel includes a delivery pipe configured to store the gaseous fuel, a cylinder head including an insertion hole opened to a combustion chamber of the internal combustion engine, an injector, and an elastic member. The injector includes a main body connected to the delivery pipe and a nozzle extending from the main body and inserted into the insertion hole. The injector is configured to inject the gaseous fuel in the delivery pipe from the nozzle into the combustion chamber. The elastic member is disposed in a compressed state between the main body and the cylinder head. The elastic member is configured to apply, to the main body, a force that pushes the main body toward the delivery pipe.

Other features and aspects will be apparent from the following detailed description, the drawings, and the claims.

### BRIEF DESCRIPTION OF THE DRAWINGS

FIG. 1 is a schematic diagram of an internal combustion engine.

FIG. 2 is a perspective view of the injector shown in FIG. 1.

FIG. 3 is a perspective view of a location at which the injector and the elastic member shown in FIG. 2 are connected.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Embodiment

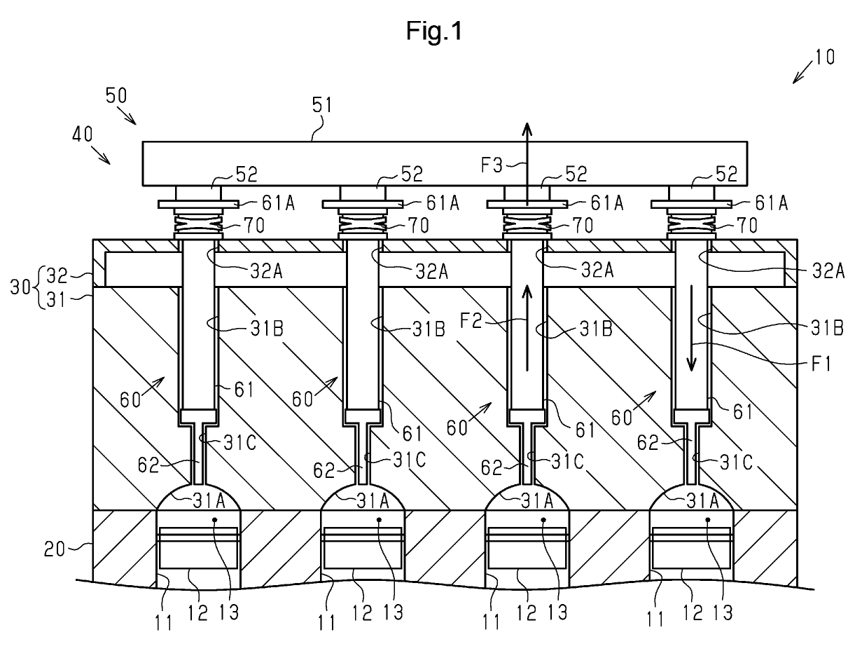

An internal combustion engine 10 of the present disclosure will be described with reference to FIGS. 1 - 3. An internal combustion engine 10 shown in FIG. 1 is a drive source of a vehicle. The internal combustion engine 10 uses a gaseous fuel. The gaseous fuel is, for example, hydrogen fuel. The gaseous fuel may be natural gas fuel.

### Schematic Structure of Internal Combustion Engine

The internal combustion engine 10 includes a cylinder block 20. The cylinder block 20 has, for example, four cylinders 11.

Each of the cylinders 11 opens in the upper surface of the cylinder block 20. A piston 12 is accommodated in each cylinder 11. The piston 12 can reciprocate in the cylinder 11. The piston 12 is connected to a crankshaft via a connecting rod. The connecting rod and the crankshaft are not shown.

The internal combustion engine 10 includes a cylinder head 30. The cylinder head 30 is disposed above the cylinder block 20. The cylinder head 30 includes a cylinder head body 31 and a cover 32. A valve actuation mechanism and the like are disposed on an upper surface of the cylinder head body 31. The cover 32 is fixed to the upper end of the cylinder head body 31 so as to cover the cylinder head body 31, the valve actuation mechanism, and the like.

The cylinder head body 31 is fixed to an upper end of the cylinder block 20. The cylinder head body 31 has recesses 31A each corresponding to one of the cylinders 11. The recesses 31A are located in the lower surface of the cylinder head body 31. The recesses 31A are recessed upward in the axial direction of the cylinders 11. A combustion chamber 13 is defined by inner wall of each recess 31A, the inner wall of the corresponding cylinder 11, and the top surface of the corresponding piston 12.

The cylinder head body 31 is provided with first through-holes 31B communicating with the respective combustion chambers 13. The first through-holes 31B extend through the cylinder head body 31 in the vertical direction. The cover 32 of the cylinder head 30 is provided with second through-holes 32A respectively corresponding to the first through-holes 31B. The second through-holes 32A are provided in the cover 32 at positions corresponding to the positions of the respective first through-holes 31B of the cylinder head body 31. The axis of each second through-hole 32A agrees with the axis of the corresponding first through-hole 31B.

An injector 60 is inserted into each set of a first through-hole 31B and a second through-hole 32A. Each injector 60 is attached to the cylinder head 30 by inserting the injector 60 into the corresponding set of a first through-hole 31B and a second through-hole 32A.

Each first through-hole 31B includes an insertion hole 31C in which a nozzle 62 of the injector 60, which is discussed below, is disposed. Each insertion hole 31C opens to the corresponding combustion chamber 13 of the internal combustion engine 10. The insertion holes 31C are provided in a lower portion of the cylinder head body 31.

### Fuel Supply Device

The internal combustion engine 10 includes a fuel supply device 40. The fuel supply device 40 includes a delivery pipe 50 for storing gaseous fuel, the injectors 60, and elastic members 70. In FIG. 1, cross sections of a cylinder block 20 and a cylinder head 30 are shown, and a side view of a fuel supply device 40 is shown.

### Delivery Pipe

Gaseous fuel is supplied to the delivery pipe 50 by a fuel pump. The delivery pipe 50 has a substantially cylindrical shape. The delivery pipe 50 includes a pipe body 51 and multiple branch portions 52. The pipe body 51 extends in the arrangement direction of the cylinders 11 above the cylinder head 30.

The branch portions 52 have a substantially cylindrical shape. Each branch portion 52 protrudes from the pipe body 51 toward the corresponding set of a first through-hole 31B and a second through-hole 32A of the cylinder head 30. One of the injectors 60 for supplying fuel to the internal combustion engine 10 is connected to each branch portion 52.

### Injectors

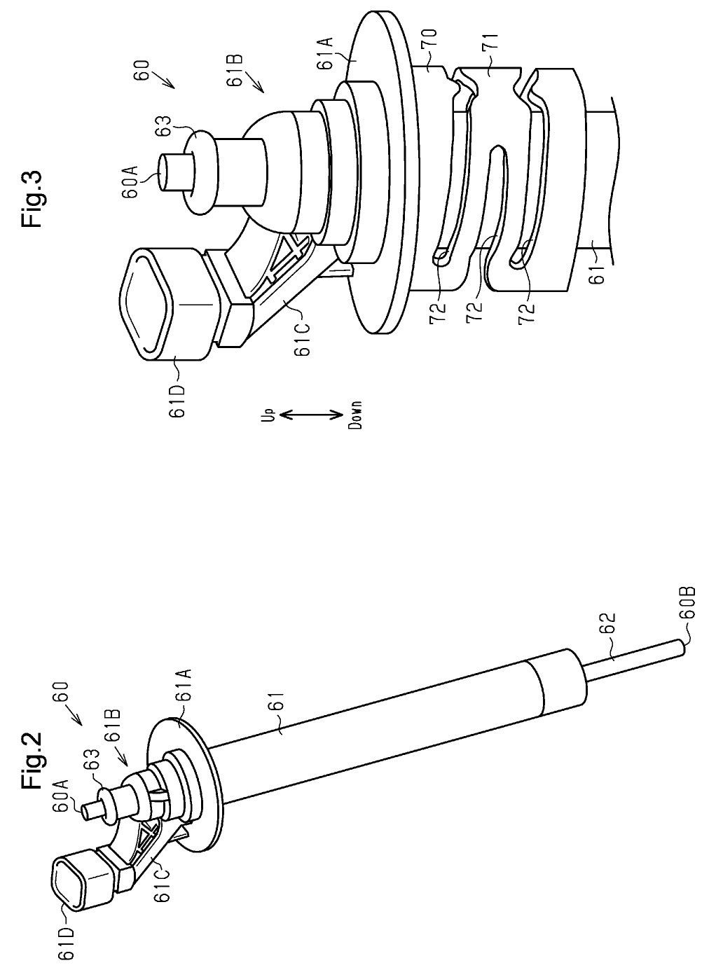

As shown in FIG. 2, each injector 60 includes a main body 61 and a nozzle 62. The main body 61 has a substantially cylindrical shape. The main body 61 is connected to the delivery pipe 50. The nozzle 62 extends from the main body 61. The outer diameter of the nozzle 62 is smaller than the outer diameter of the main body 61.

As shown in FIG. 1, with the injectors 60 attached to the cylinder head 30, at least a part of the nozzle 62 disposed in each insertion hole 31C of the cylinder head 30 is located in the combustion chamber 13. Each injector 60 injects gaseous fuel from the nozzle 62 into the corresponding combustion chamber 13 of the internal combustion engine 10.

An end portion of the nozzle 62 on a side opposite to the main body 61 in the axial direction of the injector 60 is referred to as a tip end 60B of the injector 60. In the axial direction of the injector 60, an end portion of the main body 61 opposite to the nozzle 62 is referred to as a base end 60A of the injector 60.

As shown in FIG. 2, an O-ring 63 is attached to a portion of the injector 60 near the base end 60A thereof. In a state where the injector 60 is attached to the delivery pipe 50, the base end 60A of the injector 60 is inserted into the cylinder of the branch portion 52. A gap between the outer peripheral surface of the main body 61 of the injector 60 and the inner peripheral surface of the branch portion 52 is sealed by an O-ring 63.

The gaseous fuel stored in the delivery pipe 50 flows from the base end 60A of the injector 60 toward the tip end 60B of the injector 60. In the following description, a side where a base end 60A of the injector 60 is located may be referred to as an upper side, and a side where a tip end 60B of the injector 60 is located may be referred to as a lower side.

As shown in FIG. 2, the main body 61 includes a flange 61A. The flange 61A protrudes from the outer peripheral surface of the main body 61 over the entire circumferential direction. The flange 61A has a ring shape when the injector 60 is viewed from the axial direction of the injector 60. As shown in FIG. 1, the diameters of the flange 61A and the first through-hole 31B are larger than each other.

As shown in FIG. 2, a portion of the main body 61 between the flange 61A and the base end 60A includes a step portion 61B in which the shape of the outer periphery of the main body 61 changes in a stepped manner. In the step portion 61B, the outer diameter of the main body 61 decreases toward the base end 60A of the injector 60.

The main body 61 includes a protruding portion 61C. The protruding portion 61C has a flat quadrangular tubular shape. The protruding portion 61C protrudes from the outer peripheral surface of the main body 61. The protruding portion 61C is located between the flange 61A and the base end 60A of the main body 61. The protruding portion 61C extends while being inclined such that the distal end of the protruding portion 61C is positioned upward.

A connector 61D for transmitting an electrical signal is connected to a distal end of the protruding portion 61C. The connector 61D has a substantially rectangular box shape that opens upward. Multiple terminals are arranged inside the connector 61D, and the multiple terminals are connected to an electromagnetic valve or the like incorporated in the injector 60.

### Elastic Members

As shown in FIGS. 1 and 3, each elastic member 70 is disposed in a compressed state between the main body 61 of the corresponding injector 60 and the cylinder head 30. The upper end of the elastic member 70 is in contact with the lower end of the flange 61A of the injector 60. The lower end of the elastic member 70 is in contact with the upper end of the cover 32 of the cylinder head 30. The elastic member 70 is attached to a part of the injector 60 that is below the flange 61A.

An example of the elastic member 70 is a spring 71. The spring 71 has a C-shape in a plan view. The spring 71 has at least one slit 72 extending in the circumferential direction of the spring 71. The spring 71 is provided with multiple slits 72. The multiple slits 72 are arranged in the vertical direction. The spring 71 can expand and contract in the vertical direction by being elastically deformed so that the width of each slit 72 changes. In the present embodiment, the spring 71 is attached to the injector 60 in a state where the spring 71 is elastically deformed such that the width of each slit 72 is reduced.

The spring 71 of the present embodiment has a clamp structure for clamping the main body 61 of the injector 60. The spring 71 is attached to the injector 60 by sandwiching the main body 61 of the injector 60.

A fuel pressure load F1, which pushes the main body 61 toward the cylinder head 30, is applied to the main body 61. The fuel pressure load F1 is generated by the pressure of the gaseous fuel supplied from the delivery pipe 50 to the injector 60. A combustion pressure load F2, which pushes the injector 60 toward the delivery pipe 50, is applied to the injector 60. The combustion pressure load F2 is generated by the combustion pressures in each combustion chamber 13. The elastic member 70 applies, to the main body 61, a force that pushes the main body 61 toward the delivery pipe 50. The force that the elastic member 70 applies to the main body 61 is referred to as an elastic load F3. In FIG. 1, the directions of the forces of the fuel pressure load F1, the combustion pressure load F2, and the elastic load F3 are indicated by arrows.

The fuel pressure load F1 is smaller than the sum of the combustion pressure load F2 and the elastic load F3. The elastic load F3 is preferably greater than the fuel pressure load F1.

The present embodiment has the following advantages.

(1) In the present embodiment, the internal combustion engine 10 uses gaseous fuel. The internal combustion engine 10 includes a delivery pipe 50, a cylinder head 30, an injector 60, and an elastic member 70. The delivery pipe 50 stores the gaseous fuel. The cylinder head 30 has an insertion hole 31C that opens to the combustion chamber 13 of the internal combustion engine 10. The injector 60 includes a main body 61 connected to the delivery pipe 50, and a nozzle 62 extending from the main body 61 and inserted into the insertion hole 31C. The injector 60 injects the gaseous fuel in the delivery pipe 50 into the combustion chamber 13 from the nozzle 62. The elastic member 70 is disposed in a compressed state between the main body 61 and the cylinder head 30. The elastic member 70 applies, to the main body 61, a force that pushes the main body 61 toward the delivery pipe 50.

According to the above configuration, since the injector 60 is pushed toward the delivery pipe 50 by the elastic member 70, it is not necessary to make the elastic load F3 larger than the combustion pressure load F2. Therefore, an increase in the force acting on the injector 60 can be suppressed.

(2) The fuel pressure load F1 is smaller than the sum of the combustion pressure load F2 and the elastic load F3. Therefore, the injector 60 is constantly pressed toward the delivery pipe 50 by the elastic member 70. Therefore, the injector 60 can be suitably positioned.

### Modifications

The present disclosure can be implemented with the following modifications. The present disclosure and the following modifications can be implemented in combination with each other as long as there is no technical contradiction.

The position at which the injector 60 is disposed is not limited to the first through-hole 31B and the second through-hole 32A of the cylinder head 30. For example, the injector 60 may be disposed in a through-hole provided in a side surface of the cylinder block 20. In this case, the gaseous fuel may be injected from the side surface of the cylinder 11 by the injector 60.

The shape of the main body 61 of the injector 60 is not limited to the example of the embodiment. A portion of the main body 61 between the flange 61A and the base end 60A may have, for example, a square tubular shape. It is sufficient that the injector 60 can inject fuel at least from the tip end 60B.

The number of the cylinders 11 is not limited to the example of the embodiment. The number of the cylinders 11 may be five or more, or may be three or less.

The structure of the spring 71 is not limited to the example of the embodiment. The spring 71 may have a structure like a coil spring.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An internal combustion engine using a gaseous fuel, comprising:
a delivery pipe configured to store the gaseous fuel;
a cylinder head including an insertion hole opened to a combustion chamber of the internal combustion engine;
an injector including a main body connected to the delivery pipe and a nozzle extending from the main body and inserted into the insertion hole, the injector being configured to inject the gaseous fuel in the delivery pipe from the nozzle into the combustion chamber; and
an elastic member disposed in a compressed state between the main body and the cylinder head, the elastic member being configured to apply, to the main body, a force that pushes the main body toward the delivery pipe.

2. The internal combustion engine according to claim 1, wherein
a force that is generated by a pressure of the gaseous fuel supplied from the delivery pipe to the injector and pushes the main body toward the cylinder head is a fuel pressure load,
the force that is applied to the main body by the elastic member and pushes the main body toward the delivery pipe is an elastic load,
a force that is generated by a combustion pressure in the combustion chamber and pushes the injector toward the delivery pipe is a combustion pressure load, and
the fuel pressure load is smaller than a sum of the elastic load and the combustion pressure load.
